(19) United States
(12) Patent Application Publication
(10) Pub. No.: US 2026/0051113 A1
(43) Pub. Date: Feb. 19, 2026

(54) METHOD AND SYSTEM FOR SIMULATION OF LIGHT POLLUTION BY SATELLITE SYSTEM

(71) Applicant: WILDSTAR, LLC, Saratoga, CA (US)

(72) Inventor: Amirebrahim Darabi, San Francisco, CA (US)

(73) Assignee: WILDSTAR, LLC, Saratoga, CA (US)

(21) Appl. No.: 18/982,555

(22) Filed: Dec. 16, 2024

Related U.S. Application Data
(60) Provisional application No. 63/683,702, filed on Aug. 16, 2024.

(51) Int. Cl. G06T 15/50

(52) U.S. Cl. CPC G06T 15/506; G06T 2200/24; G06T 2215/16

(57) ABSTRACT

The disclosed technology is generally directed to a method for simulating light pollution by a satellite system including at least one satellite. In one example of the technology, the method may include receiving orientation and solar panel parameters associated with the satellite, a position of the Earth with respect to the Sun, importing a database including multiple point of interests (POIs) on the Earth, and determining a surface roughness parameter of the satellite using a Gaussian distribution model. Based on the orientation and solar panel parameters, the position of the Earth, and the surface roughness parameter: simulating the light pollution by the satellite to iteratively determine the light pollution at the POIs. The method may include storing the light pollution determined at the POIs in a buffer and dynamically rendering a user interface to display a visualization representing the light pollution by the satellite at the POIs.

### CROSS REFERENCE TO RELATED APPLICATIONS

This application claims the benefit of U.S. Provisional Application Ser. No. 63/683,702, filed on Aug. 16, 2024, the disclosure of which is incorporated herein by reference.

### TECHNICAL FIELD

This disclosure is directed to simulation of a satellite system, and more particularly, to methods and systems for simulation of light pollution by one or more satellites of the satellite system.

### BACKGROUND

Satellites have become important tools for various applications, including communication, Earth observation, navigation, and scientific research. The design and operation of the satellites require meticulous planning and analysis to ensure mission success and longevity in space environments. When planning for complexities of space missions, satellite simulation is important with an aim to evaluate performance at a system level. Space mission modelling using simulation is developing rapidly alongside the complex challenges of today and tomorrow's space missions. Simulation software has become an important tool for satellite engineers and researchers, allowing them to model and analyze satellite behavior under different operating conditions.

Light pollution due to satellites occurs when the sunlight is reflected on the Earth by reflective surfaces of the satellite such as surfaces made of aluminum, silver, titanium, and the like. Light pollution from satellites has become a significant issue for the astronomy community due to the potential effect on astronomical observation and scientific discovery. With increasing number of satellites being launched in space, the problem of light pollution may get more challenging.

Traditional methods for the satellite simulation often rely on manual calculations with limited functionality. These approaches may lack the accuracy, flexibility, and scalability to address the complexities of modern satellite systems. In recent years, there has been a growing demand for advanced simulation software capable of accurately modeling the behavior of the satellites in a wide range of scenarios. Such software enables engineers, researchers, and mission planners to simulate satellite orbits, predict orbital maneuvers, optimize mission parameters, and analyze system performance in a virtual environment.

Existing software packages for the satellite modeling and simulation offer some capabilities for simulating the satellite dynamics and mission planning, but suffer from limitations such as complexity, accuracy, performance, and integration challenges. Therefore, in light of the foregoing, there is a need for a technical solution to overcome the challenges associated with conventional systems for satellite simulation.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, an exemplary embodiment of the present disclosure may provide a method for simulating light pollution by a satellite system including at least one satellite. Implementations of the described techniques may include hardware, a method or process, or a non-transitory, a computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features.

The method may include receiving a set of orientation parameters and a set of solar panel parameters associated with the at least one satellite, and a position of the Earth with respect to the Sun. The method may further include importing a database including a plurality of point of interests on the Earth. The method may further include determining a surface roughness parameter of the at least one satellite using a Gaussian distribution model. Based on at least one of the set of orientation parameters, the set of solar panel parameters, the position of the Earth with respect to the Sun, the surface roughness parameter, and the database: simulating the light pollution by the at least one satellite to determine the light pollution at the plurality of point of interests. The light pollution by the at least one satellite is iteratively determined as the at least one satellite traverses through a respective orbit of the at least one satellite. The method may further include storing the light pollution determined at the plurality of point of interests in a buffer after simulation. The method may furthermore include dynamically rendering a user interface to display a visualization representing the light pollution by the at least one satellite at the plurality of point of interests based on the iterative determination of the light pollution. Other embodiments of this aspect include corresponding computer systems, apparatus, and computer programs recorded on one or more computer storage devices, each configured to perform the actions of the methods.

Implementations may include one or more of the following features. In some implementations, the plurality of point of interests on the Earth may correspond to geographical locations of a plurality of observatory sites on the Earth.

In some implementations, the set of orientation parameters may include at least one of: a position and an orientation of the at least one satellite.

In some implementations, the set of solar panel parameters may include at least one of: a number of solar panels, dimensions of the solar panels, a model of the solar panels, and a material of the solar panels.

In some implementations, the material of the solar panels may correspond to one of aluminum, silver, and titanium.

In some implementations, the Gaussian distribution model may include at least one of: a probability model to determine an incoming energy from the Sun at the at least one satellite, a probability model to determine the surface roughness parameter of the at least one satellite, and a probability model to determine an outgoing energy by a surface of the at least one satellite.

In some implementations, the method may further include determining a number of satellites in the satellite system that cause light pollution at a point of interest of the plurality of point of interests to determine a cumulative light pollution for the point of interest.

In some implementations, the set of orientation parameters and the set of solar panel parameters are input based on an interaction with the user interface rendered on a computing device.

In some implementations, the light pollution by the at least one satellite may be iteratively determined when at least one of the set of orientation parameters and the set of solar panel parameters are modified.

In another general aspect, a method may be provided for simulating light pollution by a satellite system including a constellation of satellites. The method may include receiving a set of orientation parameters and a set of solar panel parameters associated with each satellite of the constellation of satellites, and a position of the Earth with respect to the Sun. The method may further include importing a database comprising a plurality of point of interests on the Earth. The method may further include determining a surface roughness parameter of each satellite of the constellation of satellites using a Gaussian distribution model. Based on at least one of the set of orientation parameters, the set of solar panel parameters, the position of the Earth with respect to the Sun, the surface roughness parameter, and the database: simulating, via a parallel processor, the light pollution by each satellite of the constellation of satellites to determine the light pollution at the plurality of point of interests. The light pollution by each satellite of the constellation of satellites are iteratively determined as each satellite of the constellation of satellites traverse through a respective orbit of each satellite of the constellation of satellites. The method may further include storing the light pollution determined at the plurality of point of interests in a buffer after simulation. The method may furthermore include dynamically rendering a user interface to display a visualization representing the light pollution by each satellite of the constellation of satellites at the plurality of point of interests based on the iterative determination of the light pollution. Other embodiments of this aspect include corresponding computer systems, apparatus, and computer programs recorded on one or more computer storage devices, each configured to perform the actions of the methods.

In another aspect, an exemplary embodiment of the present disclosure may provide a system for simulating light pollution by a satellite system comprising at least one satellite. The system includes at least one hardware-based processor and memory. The memory comprises processor-executable instructions encoded on a non-transient processor-readable media. The processor-executable instructions, when executed by the at least one hardware-based processor, configure the system to receive a set of orientation parameters and a set of solar panel parameters associated with the at least one satellite, and a position of the Earth with respect to the Sun, import a database comprising a plurality of point of interests on the Earth, and determine a surface roughness parameter of the at least one satellite using a Gaussian distribution model. Based on at least one of the set of orientation parameters, the set of solar panel parameters, the position of the Earth with respect to the Sun, the surface roughness parameter, and the database, the processor-executable instructions, when executed by the at least one hardware-based processor, further configure the system to simulate the light pollution by the at least one satellite to determine the light pollution at the plurality of point of interests. The light pollution by the at least one satellite is iteratively determined as the at least one satellite traverses through a respective orbit of the at least one satellite. Further, the processor-executable instructions, when executed by the at least one hardware-based processor, further configure the system to store the light pollution determined at the plurality of point of interests in a buffer after simulation and dynamically rendering a user interface to display a visualization representing the light pollution by the at least one satellite at the plurality of point of interests based on the iterative determination of the light pollution.

In yet another aspect, an exemplary embodiment of the present disclosure may provide a non-transitory computer-readable medium storing a set of instructions for simulating light pollution by a satellite system comprising at least one satellite. The set of instructions comprising one or more instructions that, when executed by one or more processors of a device, cause the device to receive a set of orientation parameters and a set of solar panel parameters associated with the at least one satellite, and a position of the Earth with respect to the Sun, import a database comprising a plurality of point of interests on the Earth, and determine a surface roughness parameter of the at least one satellite using a Gaussian distribution model. Based on at least one of the set of orientation parameters, the set of solar panel parameters, the position of the Earth with respect to the Sun, the surface roughness parameter, and the database, the one or more instructions that, when executed by the one or more processors of a device, further cause the device to simulate the light pollution by the at least one satellite to determine the light pollution at the plurality of point of interests. The light pollution by the at least one satellite is iteratively determined as the at least one satellite traverses through a respective orbit of the at least one satellite. Further, the one or more instructions that, when executed by the one or more processors of a device, further cause the device to store the light pollution determined at the plurality of point of interests in a buffer after simulation and dynamically rendering a user interface to display a visualization representing the light pollution by the at least one satellite at the plurality of point of interests based on the iterative determination of the light pollution.

Further aspects, features, applications, and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIG. 1 is a block diagram illustrating a system environment for simulating a satellite system in which aspects of the technology may be employed;

FIG. 2A is a block diagram illustrating an application server of FIG. 1 in which aspects of the technology may be employed;

FIG. 2B is a block diagram illustrating a parallel processor of FIG. 2A in which aspects of the technology may be employed;

FIG. 2C is a block diagram illustrating a light pollution subsystem of FIG. 2B in which aspects of the technology may be employed;

FIG. 3 is a block diagram that illustrates an exemplary user interface rendered on the computing device in which aspects of the technology may be practiced;

FIGS. 4A-4D are diagrams that represent exemplary user interfaces rendered on the computing device in which aspects of the technology may be practiced;

FIG. 5 illustrates a flow chart of a method for simulating light pollution by the at least one satellite according to aspects of the disclosed technology;

FIG. 6 illustrates a flow chart of a method for simulating light pollution by each satellite of the constellation of satellites according to aspects of the disclosed technology; and

FIG. 7 is a diagram illustrating one example of computing device in which aspects of the technology may be practiced.

In the drawings, similar reference numerals refer to similar parts throughout the drawings unless otherwise specified. These drawings are not necessarily drawn to scale.

### DETAILED DESCRIPTION

Technologies are provided for simulation of a satellite system. Technologies are also provided for simulating light pollution by the satellite system. The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Implementations of the techniques described herein may include hardware, a method or process, or a non-transitory computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features. Prior to describing exemplary embodiments that incorporate the features of the present disclosure, a discussion of concepts that are applicable to the exemplary embodiments will be provided.

Satellites are important components for various applications, including communication, Earth observation, and scientific research, but precise control and stability of the satellites is important for their functionality and longevity. The functions primarily involve managing satellite orbits, controlling orientation (attitude) of the satellites, and ensuring stability against external forces. As used herein, the term “attitude” refers to the orientation or position of the satellite with respect to a reference frame, typically the celestial sphere or the Earth. The attitude of a satellite describes how the satellite is pointed in space and is characterized by its angular position along three principal axes called the roll axis, pitch axis and yaw axis. Attitude may be specified using a set of Euler angles or direction cosines that define how the satellite is oriented in three-dimensional space. These angles describe the rotations to transform the satellite's coordinate system to a fixed reference frame, such as the Earth-centered inertial frame.

Additionally, the satellites may need to perform maneuvers, maintain safety, and support continuous communication with ground terminals and/or other satellites. Technological advancements in satellite control and stabilization systems may enhance or improve the reliability and performance in various tasks, from telecommunications to space exploration and scientific research.

Utilization of satellite simulation may improve such satellite control systems by enabling accurate orbit prediction, autonomous maneuvers, real-time attitude control, anomaly detection, efficient communication, collision avoidance, predictive maintenance, resource management, mission planning, and space weather prediction. Satellite simulation driven advancements may optimize satellite operations, extend their lifespan, improve data collection, enhance communication efficiency, ensure safety, and enable proactive maintenance, contributing to the overall effectiveness of satellites in applications ranging from telecommunications to Earth observation and space exploration.

In the field of the satellite simulation, traditional methods face an array of complex technical challenges that have become increasingly pronounced in modern satellite systems. Traditional methods for the satellite simulation include complex mathematical models based on orbital mechanics, dynamics, and environmental factors. Implementing and solving the complex mathematical models may be challenging, requiring specialized knowledge and computational resources. Traditional methods are built for specific applications or scenarios, limiting their flexibility to adapt to different mission requirements or satellite configurations. Traditional simulation software packages fail to comprehensively simulate many problems and issues related to operation of satellite(s) in a single simulation software package.

Additionally, traditional methods may struggle to scale up to simulate large satellite constellations or complex mission scenarios. As the number of satellites or simulation parameters increase, computational resources and simulation runtimes may become prohibitive. Integrating traditional simulation tools with other software systems or workflows may be difficult. Lack of interoperability and standardized data formats may require manual data conversion or custom integration efforts, leading to inefficiencies and errors. The traditional methods may lack advanced visualization and analysis features, making it challenging for users to interpret simulation results effectively.

Integrating real-world data, such as satellite ephemerides, atmospheric conditions, or sensor measurements, into the traditional methods may be challenging. Traditional methods are complex and require specialized knowledge to use effectively and hence, users may need to invest significant time and effort in learning how to use the software, which can be a barrier for newcomers to the field. Traditional methods lack storing previous simulation results during simulation and hence a user has to start the simulation from scratch each time they run the simulation.

In accordance with the disclosed embodiments, a system environment is provided that may be used to simulate most, if not all, problems related to modelling operation and performance of a single satellite and/or a constellation of satellites in the space. Calculations can be implemented using parallel computing and a vectorization technique, which is optimized to rapidly perform the calculations in parallel to deliver real-time or near real-time output results. The system environment provides the option to communicate with matrix laboratory (MATLAB) to import and export data for further analysis. Further, the system environment is a user friendly environment and is easy to use. Furthermore, the system environment is embedded with a satellite attitude control and a sensor fusion based on machine learning. Additionally, the system environment includes storing of simulation results and the previously stored results are used further for subsequent simulations.

The system environment facilitates addition of constellations to a set of databases using a first set of standardized parameters that include satellite constellation orbits (e.g., number of satellites and orbital parameters), basic attitude profiles (e.g., roll, pitch, and yaw as a function of sun angle), light reflection properties (e.g., simplified spacecraft shape and size, and surface roughness). Further, the system environment facilitates addition of observatories to the set of databases using a second set of standardized parameters that include a telescope location, a telescope aperture, a telescope pointing direction, a telescope sensitivity or performance in operating modes of interest (e.g., field of view, integration time, wavelength bands, throughput, and detector quantum efficiency).

The system environment may perform simulation of basic orbit propagation of constellations, apply attitude profiles, and predict light pollution effects on the ground. The system environment may assess the impact of light pollution produced by constellations of satellites on telescopes in a given operating mode. The system environment may produce reports assessing important performance metrics or criteria for simulated scenarios.

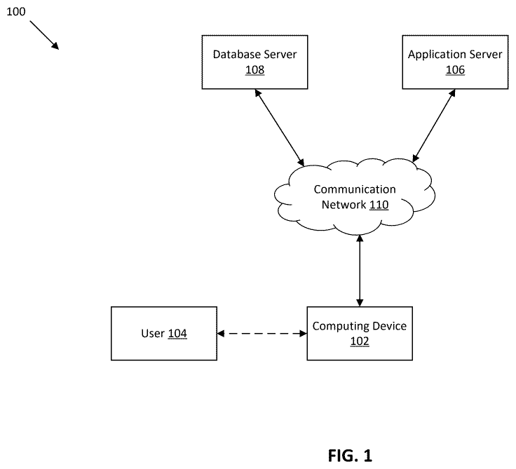

Having given this description of the system environment for the satellite simulation that can be applied within the context of the present disclosure, technologies will now be described for simulating orbit propagation, link budget, light pollution, power analysis, heat transfer, and controlling of an orientation of the satellite system based on various parameters of the satellite system will now be described with reference to FIGS. 1-7.

FIG. 1 is a block diagram illustrating a system environment 100 for simulating a satellite system in which aspects of the technology may be employed. The satellite system may include at least one satellite or may correspond to a constellation of satellites. The system environment 100 includes a computing device 102, a user 104, an application server 106, and a database server 108. The computing device 102, the application server 106, and the database server 108 may be coupled to each other via a communication network 110.

The computing device 102 may include suitable logic, circuitry, interfaces, and/or code, executable by the circuitry, that may be configured to perform one or more operations. The one or more operations may be performed by utilizing the service application running on the computing device 102. The service application may be associated with a simulation software and hosted by application server 106. In at least some embodiments, the computing device 102 may be utilized by the user 104 to input a set of parameters associated with the satellite system to simulate the satellite system within the simulation software. Further, the computing device 102 may be utilized, by the user 104, for interacting with a user interface so as to provide one or more inputs for initiating the one or more operations associated with the simulation of the satellite system.

Additionally, the computing device 102 may be utilized, by the user 104, to view the user interface rendered on the computing device 102. Various modes of input that may be utilized, by the user 104, to input the set of parameters include, but are not limited to, a touch-based input, a text-based input, a voice-based input, a gesture-based input, or a combination thereof. Examples of the computing device 102 may include, but are not limited to, a personal computer, a laptop, a smartphone, and a tablet computer.

The user 104 is an individual, such as satellite engineers, researchers, mission planners, and the like, who may want to perform simulation of the satellite system utilizing the system environment 100. The user 104 may initiate simulation of the satellite system by inputting the set of parameters associated with the satellite system. In at least some embodiments, the simulation of the satellite system may be initiated, by the user 104, by utilizing the service application running on the computing device 102.

The application server 106 may include suitable logic, circuitry, interfaces, and/or code, executable by the circuitry, that may be configured to perform one or more operations for simulation of the satellite system. The application server 106 may be a computing device, which may include a software framework that may be configured to create the application server 106 implementation and perform the various operations associated with simulation of the satellite system.

The application server 106 may be realized through various web-based technologies, such as, but are not limited to, a Java web-framework, a .NET framework, a PHP framework, a python framework, or any other web-application framework. The application server 106 may also be realized as a machine-learning model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g. Bayesian networks), neural networks, decision tree learning methods, other non-linear training techniques, data fusion, utility-based analytical systems, or the like. Examples of the application server 106 may include, but are not limited to, a personal computer, a laptop, or a network of computer systems.

In at least some embodiments, the application server 106 may be configured to process, control, and manage various functionalities and operations such as user authentication, reception of the set of parameters, simulation, visualization, and the like. For example, the application server 106 may be further configured to receive user credentials that includes a username and a password of the user 104 to authenticate the user 104 from the computing device 102 via the communication network 110. Upon successful authentication of the user 104, the application server 106 may be configured to receive a set of orbital parameters from the computing device 102 via the communication network 110. Further, the application server 106 may be configured to receive a selection input from the computing device 102 via the communication network 110 whether to simulate one of link budget, light pollution, power analysis, heat transfer, and controlling of an orientation of the satellite system according to the selection by the user 104 on the computing device 102.

When the selection input indicates simulation of the link budget, the application server 106 may be configured to receive a set of link budget parameters. When the selection input indicates simulation of the light pollution, the application server 106 may be configured to receive a set of light pollution parameters. When the selection input indicates simulation of the power analysis, the application server 106 may be configured to receive a set of power analysis parameter. When the selection input indicates simulation of the heat transfer, the application server 106 may be configured to receive a set of heat transfer parameters. When the selection input indicates simulation of the controlling of the orientation of the satellite system, the application server 106 may be configured to receive a set of orientation parameters. The application server 106 may be further configured to import a set of databases and information from the database server 108 for simulation of the satellite system.

Further, the application server 106 may be configured to simulate orbit propagation of the satellite system based on the set of orbital parameters. Additionally, the application server 106 may be configured to simulate one of the link budget, the light pollution, the power analysis, the heat transfer, and the controlling of the orientation of the satellite system based on the selection input and respective parameters, respective databases received or imported by the application server 106.

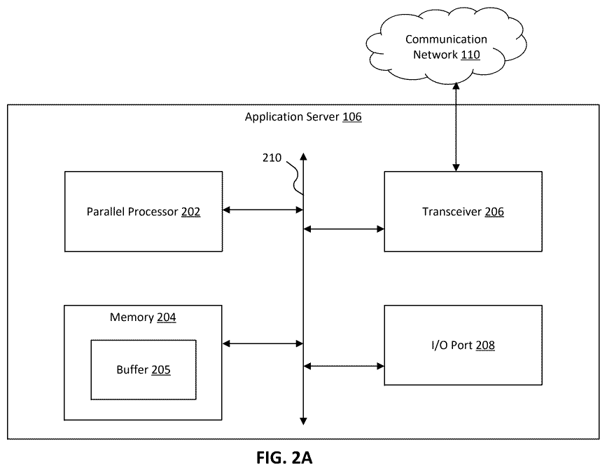

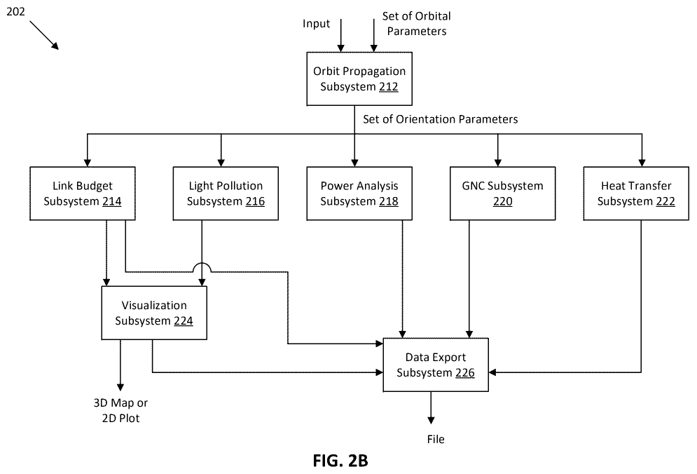

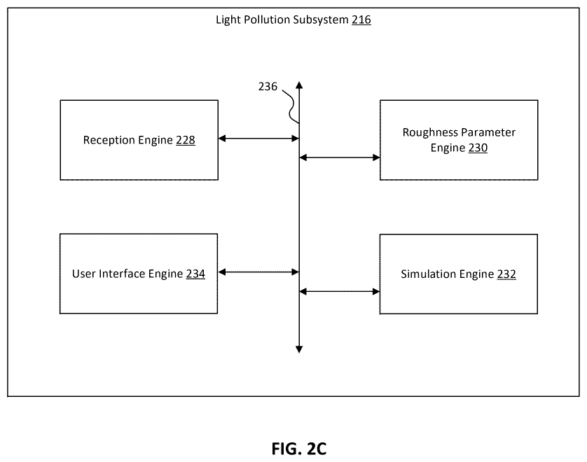

The application server 106 may be further configured to display a visualization representing the orbit propagation of the satellite system. In at least some embodiments, the visualization corresponds to at least one of a two-dimensional plot, a three-dimensional model of the Earth, and a two-dimensional contour through the user interface rendered on the computing device 102 via the communication network 110. Additionally, along with the visualization representing the orbit propagation of the satellite system, the application server 106 may be configured to display a visualization representing one of the link budget, the light pollution, the power analysis, the heat transfer, and the controlling of the orientation of the satellite system according to the selection input. Various operations and functionalities of the application server 106 have been described in detail in conjunction with FIGS. 2-7.

The database server 108 may include suitable logic, circuitry, interfaces, and/or code, executable by the circuitry, that may be configured to perform one or more database operations, such as receiving, storing, processing, and transmitting data, or content. The database server 108 may be a data management and storage computing device that is communicatively coupled to the computing device 102, and the application server 106 via the communication network 110 to perform the one or more database operations. Examples of the database server 108 may include, but are not limited to, a personal computer, a laptop, or a network of computer systems.

The database server 108 may be further configured to store a set of databases comprising a first database and a second database. The first database includes country borders information, ocean borders information, and shipping lanes information. The second database includes a plurality of point of interests on the Earth.

The database server 108 may be configured to transmit the first database to the application server 106 via the communication network 110 to determine the location of a user equipment during simulation of the link budget. The database server 108 may be configured to transmit the second database to the application server 106 via the communication network 110 to determine the number of satellites in the satellite system. Various operations of the database server 108 have been described in detail in conjunction with FIGS. 2-7.

The communication network 110 may include suitable logic, circuitry, interfaces, and/or code, executable by the circuitry, that may be configured to transmit messages, and requests between various entities, such as the computing device 102, the application server 106, and/or the database server 108. Examples of the communication network 110 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the system environment 100 may connect to the communication network 110 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2A is a block diagram illustrating an application server 106, in which aspects of the technology may be employed. The application server 106 includes circuitry such as a parallel processor 202, a memory 204, a transceiver 206, and an input/output (I/O) port 208 that communicate with each other by way of a communication bus 210.

The parallel processor 202 may include suitable logic, circuitry, interfaces, and/or code, executable by the circuitry, that may be configured to perform one or more operations associated with the simulation of the satellite system. Examples of the parallel processor 202 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the parallel processor 202 may be compatible with multiple operating systems. In at least some embodiments, the parallel processor 202 may act as a simulation processing engine to simulate the orbit propagation, the link budget, the light pollution, the power analysis, the heat transfer, and the controlling of the orientation of the satellite system utilizing the system environment 100.

In at least some embodiments, the parallel processor 202 may be configured to process, control, and manage various functionalities and operations such as the user authentication, the reception of the set of parameters, the simulation, and the visualization, and the like. For example, the parallel processor 202 may receive the user credentials that includes the username and the password of the user 104 to authenticate the user 104 from the computing device 102 via the communication network 110. Upon successful authentication of the user 104, the parallel processor 202 may receive the set of orbital parameters from the computing device 102. Further, the parallel processor 202 may simulate the orbit propagation of the satellite system based on the set of orbital parameters to determine the set of orientation parameters of the satellite system. The set of orientation parameters may include a velocity, a position, and orientation of the at least one satellite of the satellite system. The parallel processor 202 may store the velocity and the position of the at least one satellite of the satellite system in the memory 204. Further, the parallel processor 202 may dynamically render the user interface to display a visualization representing the orbit propagation of the at least one satellite of the satellite system.

Further, the parallel processor 202 may receive the selection input from the computing device 102 via the communication network 110 whether to simulate one of the link budget, the light pollution, the power analysis, the heat transfer, and the controlling of the orientation of the satellite system according to the selection by the user 104. When the selection input indicates simulation of link budget, the parallel processor 202 may receive the set of link budget parameters from the computing device 102. The set of link budget parameters may include the set of orientation parameters, a set of antenna parameters, a set of user equipment parameters, a set of environmental parameters, and a latitude and a longitude of the user equipment. The parallel processor 202 may further import the first database from the database server 108. The parallel processor 202 may select at least one analysis process of a plurality of analysis processes to process the set of link budget parameters. Based on the set of link budget parameters and the first database the parallel processor 202 may simulate the link budget of the at least one satellite of the satellite system using the selected at least one analysis process to determine the link budget of the at least one satellite. The parallel processor 202 may store the link budget of the satellite system in the memory 204. Further, the parallel processor 202 may dynamically render the user interface to display a visualization representing the link budget in coverage area of the of the satellite system.

When the selection input indicates simulation of the light pollution, the parallel processor 202 may receive the set of light pollution parameters from the computing device 102. The set of light pollution parameters may include the set of orientation parameters, a set of solar panel parameters, and a position of the Earth with respect to the Sun. The parallel processor 202 may import the second database from the database server 108. Further, the parallel processor 202 may determine a surface roughness parameter using a Gaussian distribution model. Based on the set of light pollution parameters, the second database, and the surface roughness parameter, the parallel processor 202 may simulate the light pollution by the satellite system to determine the light pollution at plurality of point of interests. The parallel processor 202 may store the light pollution at the plurality of point of interests in the memory 204. Further, the parallel processor 202 may dynamically render the user interface to display a visualization representing the light pollution by the satellite system at the plurality of point of interests.

When the selection input indicates simulation of the power analysis, the parallel processor 202 may receive the set of power analysis parameters from the computing device 102 via the communication network 110. The set of power analysis parameters may include the set of orientation parameters, the set of solar panel parameters, a set of peak values, a position of the Earth with respect to the Sun, and power consumption data of a set of components of the satellite system in each mode of operation of the satellite system. The parallel processor 202 may determine an amount of power generated and an amount of power consumed by the satellite system based on the set of power analysis parameters. Based on the amount of power generated and the amount of power consumed, the parallel processor may simulate the power analysis of the satellite system to determine an amount of power stored by the satellite system. The parallel processor 202 may store the data that includes the amount of power generated, the amount of power consumed, and the amount of power stored by the satellite system in the memory 204. Further, the parallel processor 202 may dynamically render the user interface to display a visualization representing the amount of power generated, the amount of power consumed, and the amount of power stored by the satellite system.

When the selection input indicates simulation of the heat transfer, the parallel processor 202 may receive the set of heat transfer parameters from the computing device 102 via the communication network 110. The heat transfer parameters may include the set of orientation parameters. The parallel processor 202 may determine an incoming heat energy from the Sun based on the position of the satellite system. Based on the incoming heat energy from the Sun, the parallel processor 202 may simulate the heat transfer of the satellite system to determine temperature of the satellite system. The parallel processor may store the temperature of the satellite system in the memory 204. Further, the parallel processor 202 may dynamically render the user interface to display a visualization representing the temperature of the satellite system.

When the selection input indicates simulation of the controlling of orientation of the satellite system, the parallel processor 202 may receive the set of orientation parameters, sensor data, and Global Navigation Satellite System (GNSS) data. Based on the set of orientation parameters, the sensor data, and the GNSS data, the parallel processor 202 may simulate the controlling of the satellite system to stabilize the satellite system using a machine learning model, such as a reinforcement learning model.

The memory 204 may include suitable logic, circuitry, interfaces, and/or code, executable by the circuitry, that may be configured to store one or more instructions that are executed by the parallel processor 202, the transceiver 206, and the I/O port 208 to perform their operations. The memory 204 includes buffer 205, which may be configured to receive and store the velocity and the position of the at least one satellite of the satellite system received from the parallel processor 202 after simulating the orbit propagation of the satellite system. When the parallel processor 202 simulates one of the link budget, the light pollution, the power analysis, the heat transfer, and the control of the satellite system, the buffer 205 may be configured to transmit the velocity and the position of the at least one satellite of the satellite system to the parallel processor 202.

The buffer 205 may be configured to receive store the link budget in the coverage area of the satellite system received from the parallel processor 202 after simulating link budget of the satellite system. The buffer 205 may be configured to receive and store the light pollution at the plurality of point of interests received from the parallel processor 202 after simulating the light pollution by the satellite system. Further, the buffer 205 may be configured to receive and store the data that includes the amount of power generated, the amount of power consumed, and the amount of power stored by the satellite system received from the parallel processor 202 after simulating the power analysis of the satellite system.

The buffer 205 may be further configured to receive and store the temperature of the satellite system received from the parallel processor 202 after simulating the heat transfer of the satellite system. Additionally, the buffer 205 may be configured to receive and store set of action and set of rewards utilized for controlling of the satellite system received from the parallel processor 202 after simulating the control of the satellite system. Examples of the buffer 205 may include, but are not limited to, a random-access memory (RAM), a read-only memory (ROM), a programmable ROM (PROM), an erasable PROM (EPROM), a flash memory.

The transceiver 206 may include suitable logic, circuitry, interfaces, and/or code, executable by the circuitry, that may be configured to transmit (or receive) data to (or from) various servers or devices, such as the computing device 102, or the database server 108. Examples of the transceiver 206 may include, but are not limited to, an antenna, a radio frequency transceiver, a wireless transceiver, and a Bluetooth transceiver. The transceiver 206 may be configured to communicate with the computing device 102 or the database server 108, via the communication network 110, using various wired and wireless communication protocols, such as TCP/IP, UDP, LTE communication protocols, or any combination thereof.

The I/O port 208 may include suitable logic, circuitry, interfaces, and/or code, executable by the circuitry, that may be configured to perform the one or more operations related to input or output features facilitated to the one or more users such as the user 104. The I/O port 208 may include various input and output devices that are configured to communicate with the parallel processor 202, the memory 204, and the transceiver 206. Examples of the input devices may include a keyboard, a mouse, a joystick, a touchscreen, a microphone, and the like. Examples of the output devices may include a display, a speaker, a headphone, and the like.

FIG. 2B is a block diagram illustrating the parallel processor 202, in which aspects of the technology may be employed. The parallel processor 202 includes an orbit propagation subsystem 212, a link budget subsystem 214, a light pollution subsystem 216, a power analysis subsystem 218, a guidance, navigation and control (GNC) subsystem 220, a heat transfer subsystem 222, a visualization subsystem 224, and a data export subsystem 226. The parallel processor 202 may be configured to simulate various functions of the at least one satellite or the constellation of satellites. It should be appreciated that the constellation of satellites may be arranged in different configurations, including low Earth orbit (LEO), medium Earth orbit (MEO), or geostationary orbit (GEO), depending on the intended application and the desired level of coverage and service.

The orbit propagation subsystem 212 may include suitable logic, circuitry, interfaces, and/or code, executable by the circuitry, that may be configured to simulate the orbit propagation of the satellite system. The orbit propagation subsystem 212 may be further configured to receive an input indicating whether to simulate orbit propagation for one of a single satellite of the constellation of satellites and a plurality of satellites of the constellation of satellites from the computing device 102 based on an interaction of the user 104 with the user interface rendered on the computing device 102. Further, the orbit propagation subsystem 212 may be configured to receive a set of orbital parameters associated with each satellite of the constellation of satellites from the computing device 102. When the input indicates to simulate the orbit propagation for the single satellite, the orbit propagation subsystem 212 may be configured to simulate the orbit propagation of the single satellite to determine a velocity and a position of the single satellite with respect to the Earth and the Sun based on the set of orbital parameters. When the input indicates to simulate the orbit propagation for the plurality of satellites, the orbit propagation subsystem 212 may be configured to simulate the orbit propagation of each of the plurality of satellites in parallel to determine a velocity and a position of each satellite of the plurality of satellites with respect to the Earth and the Sun based on the set of orbital parameters.

After the simulating of the orbit propagation of one of the single satellite and the plurality of satellites, the orbit propagation subsystem 212 may be further configured to store the velocity and the position of one of the single satellite and each of the plurality of satellites in the buffer 205. Further, the orbit propagation subsystem 212 may be configured to dynamically render the user interface to display a visualization representing the orbit propagation of one of the single satellite and the plurality of satellites. Additionally, the orbit propagation subsystem 212 may be configured to utilize the velocity and the position of one of the single satellite and each of the plurality of satellites for simulating one of link budget, light pollution, power analysis, heat transfer, and controlling of the orientation for at least one of the single satellite and the constellation of satellites based on the selection input and the respective parameters, the respective databases, and the respective information.

The link budget subsystem 214 may include suitable logic, circuitry, interfaces, and/or code, executable by the circuitry, that may be configured to determine link budget of the satellite system. The link budget subsystem 214 may be further configured to receive the set of orientation parameters and a set of antenna parameters associated with the at least one satellite. The set of orientation parameters may be received from the buffer 205. The set of antenna parameters may be received from the computing device 102 based on an interaction of the user 104 with the user interface rendered on the computing device 102.

The link budget subsystem 214 may be configured to receive a set of user equipment parameters associated with each user equipment of a plurality of user equipment within a coverage area of the at least one satellite and the set of environmental parameters from the computing device 102. The link budget subsystem 214 may be configured to receive the latitude and the longitude of the user equipment from the computing device 102. Further, the link budget subsystem 214 may be configured to import the first database from the database server 108. Furthermore, the link budget subsystem 214 may be further configured to process the set of orientation parameters, the set of antenna parameters, the set of user equipment parameters, the set of environmental parameters, the latitude and the longitude of the user equipment, and the first database by selecting at least one analysis process of a plurality of analysis processes.

Based on the set of orientation parameters, the set of antenna parameters, the set of user equipment parameters, the set of environmental parameters, the latitude and the longitude of the user equipment, and the first database, the link budget subsystem 214 may be configured to simulate a plurality of link budgets of the at least one satellite for each of the plurality of user equipment in parallel using the selected at least one analysis process to determine the link budgets of the at least one satellite for each of the plurality of user equipment. The link budget subsystem 214 may be configured to store the link budgets in the buffer 205 after the simulating the link budgets using the selected at least one analysis process. Further, the link budget subsystem 214 may be configured to dynamically render the user interface to display a visualization representing the link budgets in the coverage area of the at least one satellite.

The light pollution subsystem 216 may include suitable logic, circuitry, interfaces, and/or code, executable by the circuitry, that may be configured to simulate light pollution by the satellite system. The light pollution subsystem 216 may be further configured to receive the set of orientation parameters and the set of solar panel parameters associated with the at least one satellite, and the position of the Earth with respect to the Sun. The set of orientation parameters may be received from the buffer 205. The set of solar panel parameters and the position of the Earth with respect to the Sun may be received from the computing device 102 based on an interaction of the user 104 with the user interface rendered on the computing device 102.

The light pollution subsystem 216 may be configured to import the second database from the database server 108. The light pollution subsystem 216 may be further configured to determine the surface roughness parameter of the at least one satellite using the Gaussian distribution model. Based on at least one of the set of orientation parameters, the set of solar panel parameters, the position of the Earth with respect to the Sun, the surface roughness parameter, and the second database, the light pollution subsystem 216 may be configured to simulate the light pollution by the at least one satellite to determine the light pollution at the plurality of point of interests. The light pollution subsystem 216 may be configured to store the light pollution at the plurality of point of interests in the buffer 205 after simulation.

Further, the light pollution subsystem 216 may be configured to dynamically render the user interface to display a visualization representing the light pollution by the at least one satellite at the plurality of point of interests. Similarly, the light pollution subsystem 216 may be configured to simulate the light pollution by each satellite of the constellation of satellites to determine the light pollution at the plurality of point of interests in parallel, based on at least one of the set of orientation parameters, the set of solar panel parameters, the position of the Earth with respect to the Sun, the surface roughness parameter, and the second database.

The power analysis subsystem 218 may include suitable logic, circuitry, interfaces, and/or code, executable by the circuitry, that may be configured to simulate power analysis of a satellite system. The power analysis subsystem 218 may be configured to receive at least one of the set of orientation parameters, the set of solar panel parameters, and a set of peak values associated with the at least one satellite, and the position of the Earth with respect to the Sun. The set of orientation parameters may be received from the buffer 205. The set of solar panel parameters, the set of peak values, and the position of the Earth with respect to the Sun may be received from the computing device 102 based on an interaction by the user 104 with the user interface rendered on the computing device 102.

Based on the set of solar panel parameters and the set of peak values associated with the at least one satellite, and the position of the Earth with respect to the Sun, the power analysis subsystem 218 may be configured to determine an amount of power generated by the at least one satellite. The power analysis subsystem 218 may be configured to receive power consumption data of a set of components of the at least one satellite in each mode of a plurality of modes of operation of the at least one satellite from the computing device 102 based on an interaction by the user 104 with the user interface rendered on the computing device 102. Based on the power consumption data of the set of components in each mode, the power analysis subsystem 218 may be configured to determine an amount of power consumed by the at least one satellite.

The power analysis subsystem 218 may be configured to simulate the power analysis of the at least one satellite, based on the amount of power generated and the amount of power consumed, to determine an amount of power stored by the at least one satellite. The power analysis subsystem 218 may be further configured to repeat receiving, determining, and simulating operations to iteratively determine the amount of power generated, the amount of power consumed, and the amount of power stored as the at least one satellite traverses through a respective orbit of the at least one satellite. Furthermore, the power analysis subsystem 218 may be configured to iteratively store data in the buffer 205 after performing the power analysis of the at least one satellite. The data includes the amount of power generated, the amount of power consumed, and the amount of power stored by the at least one satellite.

Additionally, the power analysis subsystem 218 may be configured to dynamically render the user interface to display a visualization representing the amount of power generated, the amount of power consumed, and the amount of power stored by the at least one satellite as the at least one satellite traverses through the respective orbit of the at least one satellite. Similarly, the power analysis subsystem 218, may be configured to simulate, the power analysis of each satellite of the constellation of satellites in parallel, based on the amount of power generated and the amount of power consumed, to determine an amount of power stored by each satellite of the constellation of satellites.

The GNC subsystem 220 may include suitable logic, circuitry, interfaces, and/or code, executable by the circuitry, that may be configured to control orientation of the satellite system to stabilize the satellite system. The GNC subsystem 220 may be configured to receive the set of orientation parameters from the buffer 205. Based on the set of orientation parameters, the GNC subsystem 220 may be configured to implement a reinforcement learning model to control the orientation of the satellite system to stabilize the satellite system. In at least some embodiments, the reinforcement learning model is based on an actor-critic model such as an actor-critic deep deterministic policy gradient model.

Alternatively, the reinforcement learning model may be based on any of Proximal Policy Optimization (PPO), Twin Delayed DDPG (TD3), Trust Region Policy Optimization (TRPO), Soft Actor-Critic (SAC), Advantage Actor-Critic (A2C), Deep Q-Network (DQN), Asynchronous Advantage Actor-Critic (A3C), Trust Region Policy Optimization with Proximal Policy Optimization (TRPO-PPO), Deterministic Policy Gradient (DPG), Continuous Actor-Critic Learning Automaton (CACLA), Generalized Advantage Estimation (GAE), Normalized Advantage Functions (NAF), Deep Deterministic Policy Gradients from Demonstrations (DDPGfD), Policy Gradient with Parameter-Based Exploration (PGPE), Natural Actor-Critic (NAC), Maximum a Posteriori Policy Optimization (MPO), Stochastic Value Gradient (SVG), Deep Episodic Value Iteration (DEVI), Distributed Distributional Deterministic Policy Gradients (D4PG), REINFORCE with Baseline models, etc.

To implement the reinforcement learning model, the GNC subsystem 220 may be configured to predict, based on each of the set of orientation parameters, a set of actions to be implemented by the satellite system to control the orientation of the satellite system, implement the set of actions, and predict an outcome of the implementing of the set of actions to generate a set of rewards. The orientation of the satellite system is controllable, based on the set of actions and the set of rewards, to stabilize the satellite system. Additionally, the GNC subsystem 220 may be configured to dynamically render the user interface to display the visualization representing the controlling and stabilization of the satellite system.

The heat transfer subsystem 222 may include suitable logic, circuitry, interfaces, and/or code, executable by the circuitry, that may be configured to simulate heat transfer for the satellite system. The heat transfer subsystem 222 may be configured to receive the set of orientation parameters from the buffer 205. Based on the set of orientation parameters, the heat transfer subsystem 222 may be configured to determine an incoming heat energy from the Sun based on the position of the at least one satellite. The heat transfer subsystem 222 may be configured to simulate heat transfer of the at least one satellite, based on the incoming heat energy, to determine temperature of the at least one satellite. Further, when the at least one satellite enter into eclipse mode, the heat transfer subsystem 222 may be configured to determine steady state temperature of the at least one satellite.

Furthermore, the heat transfer subsystem 222 may be configured to store the temperature and the steady state temperature of the at least one satellite in the buffer 205. Additionally, the heat transfer subsystem 222 may be configured to dynamically render the user interface to display a visualization representing the temperature and the steady state temperature of the at least one satellite. Similarly, the heat transfer subsystem 222 may be configured to simulate the heat transfer of each satellite of the constellation of satellites in parallel, based on the incoming heat energy, to determine the temperature of each satellite of the constellation of satellites.

The visualization subsystem 224 may include suitable logic, circuitry, interfaces, and/or code, executable by the circuitry, that may be configured to display interactive three-dimensional (3D) maps and two-dimensional (2D) plots. In at least some embodiments, the visualization subsystem 224 may be implemented as two different versions, such as, a desktop version and a web-based version. In one example, the desktop version may utilize PyVista which is a library in python. The visualization subsystem 224 may be further configured to receive the output of the simulation of orbit propagation of the satellite system from the orbit propagation subsystem 212.

Further, the visualization subsystem 224 may be configured to receive at least one of the link budgets in the coverage area of the satellite system, the light pollution by the satellite system at the plurality of point of interests, the amount of power generated, the amount of power consumed, and the amount of power stored by the satellite system, and the temperature of the satellite system from the link budget subsystem 214, the light pollution subsystem 216, the power analysis subsystem 218, and the heat transfer subsystem 222, respectively. Furthermore, the visualization subsystem 224 may be configured to display 3D graphs of the light pollution by the satellite system at the plurality of interests, the link budget in the coverage area of the satellite system, and the like.

The data export subsystem 226 may include suitable logic, circuitry, interfaces, and/or code, executable by the circuitry, that may be configured to export the data. The data export subsystem 226 may be further configured to receive data from at least one of the link budget subsystem 214, the light pollution subsystem 216, the power analysis subsystem 218, the GNC subsystem 220, the heat transfer subsystem 222, and the visualization subsystem 224. Further, the data export subsystem 226 may be configured to export the data in a file. Examples of the file include, but are not limited to, a motion picture expert group (MPG) file, a MATLAB file, a comma separated value (CSV) and excel file, and a text file.

FIG. 2C is a block diagram illustrating the light pollution subsystem 216, in which aspects of the technology may be employed. The light pollution subsystem 216 includes a reception engine 228, a roughness parameter engine 230, a simulation engine 232, and a user interface engine 234 that communicate with each other by way of a communication bus 236.

The reception engine 228 may include suitable logic, circuitry, interfaces, and/or code, executable by the circuitry, that may perform one or more operations related to the reception of attributes associated with the simulation of the light pollution. The reception engine 228 may receive the attributes of the at least one satellite or each satellite of the constellation of satellites. The reception engine 228 may retrieve the set of orientation parameters associated with the at least one satellite and each satellite of the constellation of satellites from the buffer 205.

The application server 106 may render the user interface on the computing device 102 such that the user 104 may interact with the user interface on the computing device 102 to provide the set of solar panel parameters associated with the at least one satellite or each satellite of the constellation of satellites and the position of the Earth with respect to the Sun. The reception engine 228 may receive the set of solar panel parameters associated with the at least one satellite or each satellite of the constellation of satellites from the computing device 102. The set of solar panel parameters includes at least one of a number of solar panels, dimensions of the solar panels, a model of the solar panels, and a material of the solar panels. The dimensions of the solar panels may correspond to a length of a solar panel in meters and a width of the solar panel in meters. The material of the solar panels may correspond to one of aluminum, silver, and titanium.

The reception engine 228 may receive the position of the Earth with respect to the Sun from the computing device 102. The reception engine 228 may import the second database that includes a plurality of point of interests on the Earth from the database server 108. The plurality of point of interests on the Earth may correspond to geographical locations of a plurality of observatory sites on the Earth. Each observatory site may be a specialized facility equipped with telescopes and other instruments to observe celestial events and objects. Each observatory site may be strategically located in areas with optimal conditions for stargazing and research.

The roughness parameter engine 230 may include suitable logic, circuitry, interfaces, and/or code, executable by the circuitry, that may perform one or more operations related to determination of the surface roughness parameter associated with the light pollution. The roughness parameter engine 230 may determine the surface roughness parameter of the at least one satellite or each satellite of the constellation of satellites associated with the light pollution. Further, the roughness parameter engine 230 may determine the surface roughness parameter of the at least one satellite or each satellite of the constellation of satellites using the Gaussian distribution model. The Gaussian distribution model may include at least one of a probability model to determine an incoming energy from the Sun at the at least one satellite and/or each satellite of the constellation of satellites, a probability model to determine the surface roughness parameter of the at least one satellite and/or each satellite of the constellation of satellites, and a probability model to determine an outgoing energy by a surface of the at least one satellite and/or each satellite of the constellation of satellites.

In an exemplary embodiment, the satellite orbiting in a polar plane traverses between three different phases corresponding to three different positions of the satellite with respect to the Sun and the Earth. A first phase may correspond to a power generation phase, in which the satellite is positioned between the Earth and the Sun, and light beams coming from the Sun may be incident on a solar panel side of the satellite. In a second phase, the light beams may be incident on a bottom side of the satellite (i.e., opposite side of the solar panels), and reflects the light beams in different directions. In a third phase, the satellite is in an eclipse mode and may not receiving any light beams.

The light pollution occurs when the satellite is in the second phase, in which the satellite reflects the light beams toward the Earth in different directions. The light pollution on the Earth depends on the surface roughness of the satellite. In one example, since majority of the sunlight energy lies in a wavelength order of 500 nanometer, any surface with a roughness greater than 500 nanometer may scatter the light beams at different angles. When the satellite is orbiting around the Earth and the light beams are incident on a smooth surface, i.e., zero roughness of the surface of the satellite, the light beams may be scattered off towards the galaxy, and may not be reflected towards the Earth, thus may not cause light pollution. When the satellite is orbiting around the Earth and the light beams are incident on a rough surface, the light beams are reflected to different angles, where some of the light beams are reflected towards the Earth, resulting in light pollution for various regions, such as for observatory sites, on the Earth.

The roughness parameter engine 230 may discretize the surface of the satellite to a grid system of N*N unit cells to determine the surface roughness parameter of the satellite. The roughness parameter engine 230 may further rotate each grid of the grid system about the two major axes with random angles ϕ and θ. The two major axes are normal to a normal vector of the surface. The random angles ϕ and θ may be imported from the Gaussian distribution model with mean value of (θ, ϕ)=(0, 0) and standard deviation of σₓ=σ_{y}=σ. The Gaussian distribution is represented by equation (1) given below:

$$p ( θ , ϕ ) = \frac{1}{2 π {σ}^{2}} {e}^{\frac{- ( {ϕ}^{2} + {θ}^{2} )}{2 {σ}^{2}}} \qquad ( 1 )$$

The roughness parameter engine 230 may derive a total energy flux received by the satellite at a given position using equation (2) given below:

$${E}_{total} = ε A sin ( α ) \qquad ( 2 )$$

where,
ε may correspond to sunlight radiation constant,
A may correspond to the surface area of the satellite, and
α may correspond to a sunlight angle.

In one example, ε is equal to 1367 Joule per second square meter. Further, the roughness parameter engine 230 may determine an amount of reflected energy flux for each of the diffracted light beams sampled from the Gaussian distribution model based on the material and a color of the surface of the satellite using equation (3) given below:

$${E}_{θ , ∅} = {f}_{1} p ( θ , ϕ ) {E}_{total} \qquad ( 3 )$$

where,
f₁ may correspond to coefficient of reflected light energy from the surface of the satellite.

The roughness parameter engine 230, for each light beam, may determine the location on the Earth, that is incident by the reflected light beam from the satellite in a Compass Geodetic System (CGS) coordinate system, which may be further translated to a latitude, a longitude, and an altitude (l₁, l₂, alt). Further, the roughness parameter engine 230 may determine an amount of energy received in the neighborhood for a given point on the Earth where the light beam (θ, ϕ) collides with the Earth using equation (4) given below:

$$E ( lat , lon , alt , θ , ϕ ) = {f}_{2} sin ( β ) {E}_{θ , ϕ} \times \frac{1}{2 π {\sum }^{2}} {e}^{\frac{- ( {( lat - {l}_{1} )}^{2} + {( lon - {l}_{2} )}^{2} )}{2 {\sum }^{2}}} \qquad ( 4 )$$

where,
f₂ may correspond to an atmospheric loss coefficient,
β may correspond to an angle between the reflected sunlight beam and the horizon line at (l₁, l₂, alt), and
Σ may correspond to a standard deviation for energy flux distribution on the ground.

In at least some embodiments, for a telescope positioned at (L₁, L₂, Alt), a total amount of energy received may be determined by the roughness parameter engine 230 using equation (5) given below:

$$E ( {L}_{1} , {L}_{2} , Alt , θ , ϕ ) = {\int }_{A} {\int }_{θ , ϕ} {f}_{3} E ( {L}_{1} , {L}_{2} , Alt , θ , ϕ ) \qquad ( 5 )$$

where,
A may correspond to an area occupied by the aperture diameter of the telescope, and
f₃ may correspond to efficiency of the telescope.

An object may be seen by the telescope when an apparent magnitude of the telescope is smaller than the maximum magnitude that may be detected by the telescope. The apparent magnitude for a given frequency in the system is defined using equation (6) given below:

$${m}_{AB , f} = - 2 \text{.5} log ( S ( f ) ) - 48.60 \qquad ( 6 )$$

where,
S (f) may correspond to a spectral flux density in erg/s cm2 Hz, received from sunlight.

The simulation engine 232 may include suitable logic, circuitry, interfaces, and/or code, executable by the circuitry, that may perform one or more operations related to the simulation of the light pollution by the satellite system. The simulation engine 232 may further simulate the light pollution by the at least one satellite or each satellite of the constellation of satellites. Based on at least one of the set of orientation parameters and the set of solar panel parameters associated with the at least one satellite, the position of the Earth with respect to the Sun, the surface roughness parameter of the at least one satellite, and the second database, the simulation engine 232 may simulate the light pollution by the at least one satellite to determine the light pollution at the plurality of point of interests.

The light pollution by the at least one satellite is iteratively determined as the at least one satellite traverses through a respective orbit of the at least one satellite. In at least some embodiments, the light pollution by the at least one satellite may be iteratively determined based on the simulation timestep. For example, the simulation timestep may be ten seconds, one minute, and the like, such that the light pollution may be determined iteratively after every ten seconds, every one minute, and the like, respectively. In at least some embodiments, the light pollution by the at least one satellite may be iteratively determined when the user 104 modifies at least one of the set of orientation parameters and the set of solar panel parameters during the simulation of the light pollution. The user 104 may modify at least one of the set of orientation parameters and the set of solar panel parameters based on the interaction by the user 104 with the user interface rendered on the computing device 102. For example, each time when the user 104 modifies at least one of the set of orientation parameters and the set of solar panel parameters, the light pollution is determined iteratively. The simulation engine 232 may store the light pollution at the plurality of point of interests in the buffer 205 after simulating the light pollution by the at least one satellite. In at least some embodiments, the simulation engine 232 may determine a number of satellites in the satellite system that cause light pollution at a point of interest of the plurality of point of interests to determine a cumulative light pollution for the point of interest. For example, the simulation engine 232 may utilize the light pollution at the point of interest by at least one satellite and the number of satellites to determine the cumulative light pollution for the point of interest.

Based on at least one of the set of orientation parameters and the set of solar panel parameters associated with each satellite of the constellation of satellites, the position of the Earth with respect to the Sun, the surface roughness parameter of each satellite of the constellation of satellites, and the second database, the simulation engine 232 may simulate, via the parallel processor 202, the light pollution by each satellite of the constellation of satellites to determine the light pollution at the plurality of point of interests.

The light pollution each satellite of the constellation of satellites are iteratively determined as each satellite of the constellation of satellites traverse through a respective orbit of each satellite of the constellation of satellites. In at least some embodiments, the light pollution by each satellite of the constellation of satellites may be iteratively determined based on the simulation timestep. For example, the simulation timestep may be ten seconds, one minute, and the like, such that the light pollution may be determined iteratively after every ten seconds, every one minute, and the like, respectively. In at least some embodiments, the light pollution by each satellite of the constellation of satellites may be iteratively determined when the user 104 modifies at least one of the set of orientation parameters and the set of solar panel parameters during the simulation of the light pollution. The user 104 may modify at least one of the set of orientation parameters and the set of solar panel parameters based on the interaction by the user 104 with the user interface rendered on the computing device 102. For example, each time when the user 104 modifies at least one of the set of orientation parameters and the set of solar panel parameters, the light pollution is determined iteratively. The simulation engine 232 may store the light pollution at the plurality of point of interests in the buffer 205 after simulating the light pollution by each satellite of the constellation of satellites. In at least some embodiments, the simulation engine 232 may determine a number of satellites in the constellation of satellites that cause light pollution at a point of interest of the plurality of point of interests to determine a cumulative light pollution for the point of interest. For example, the simulation engine 232 may utilize the light pollution at the point of interest by each satellite of the constellation of satellites and the number of satellites to determine the cumulative light pollution for the point of interest.

According to an aspect of the present disclosure, the reception engine 228 may further receive multiple sets of orientation parameters for multiple constellations of satellites from the buffer 205 and multiple sets of solar panel parameters for the multiple constellations of satellites from the computing device 102. The reception engine 228 may receive the position of the Earth with respect to the Sun from the computing device 102. The reception engine 228 may import the second database that includes a plurality of point of interests on the Earth from the database server 108. The roughness parameter engine 230 may determine the surface roughness parameter of the multiple constellation of satellites. Based on the multiple sets of orientation parameters and solar panel parameters, the position of the Earth with respect to the Sun, the surface roughness parameter of the multiple constellation of satellites, and the second database, the simulation engine 232 may simulate the light pollution by the multiple constellations of satellites.

The user interface engine 234 may include suitable logic, circuitry, interfaces, and/or code, executable by the circuitry, that may perform one or more operations related to displaying the visualization of the light pollution. The user interface engine 234 may dynamically render the user interface to display the visualization representing the light pollution by the at least one satellite or each satellite of the constellation of satellites.

Further, the user interface engine 234 may dynamically render the user interface to display the visualization representing the light pollution by the at least one satellite at the plurality of point of interests based on the iterative determination of the light pollution. Furthermore, the user interface engine 234 may dynamically render the user interface to display the visualization representing the light pollution by each satellite of the constellation of satellites at the plurality of point of interests based on the iterative determination of the light pollution.

Additionally, the user interface engine 234 may display three-dimensional graphs of the light pollution by the at least one satellite or each satellite of the constellation of satellites at the plurality of point of interests. In an exemplary embodiment, the user interface engine 234 may visualize interactive three-dimensional map of the light pollution using PyVista. The user interface engine 234 may receive the light pollution by the at least one satellite or each satellite of the constellation of satellites at the plurality of point of interests from the simulation engine 232. Further, PyVista may be configured to create a plot and add the received light pollution by the at least one satellite or each satellite of the constellation of satellites at the plurality of point of interests as a three-dimensional surface. Furthermore, the position of a camera is set at one of the plurality of point of interests and PyVista may be configured to display the plot.

The data export subsystem 226 may receive the light pollution by the at least one satellite and each satellite of the constellation of satellites as light pollution data from the visualization subsystem 224 or the light pollution subsystem 216. Further, the data export subsystem 226 may be configured to export the light pollution data in a file. Examples of the file include, but are not limited to, a motion picture expert group (MPG) file, a MATLAB file, a comma separated value (CSV) and excel file, and a text file.

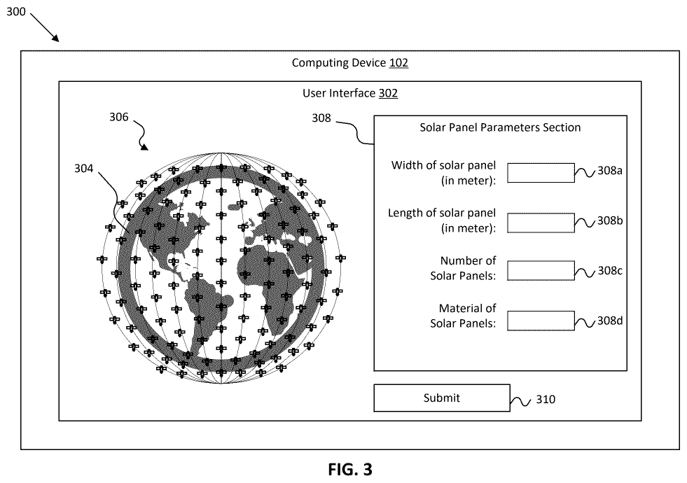

FIG. 3 is a block diagram 300 that illustrates an exemplary user interface 302 rendered on the computing device 102 in which aspects of the technology may be practiced. The user interface 302 may include representation of the Earth 304, a satellite system 306, an input section such as a solar panel parameters section 308, and one interactive interface elements such as an interactive interface element 310.

In at least some embodiments, the application server 106 may be configured to render the user interface such as the user interface 302 on the computing device 102. In at least some embodiments, the representation of the Earth 304 may correspond to 3D representation of the Earth or 2D plot of the Earth. The satellite system 306 may include the at least one satellite or may correspond to the constellation of satellites. The solar panel parameters section 308 includes first through fourth input fields 308a-308d. The first input field 308a may correspond to the width of the solar panel in meters. The second input field 308b may correspond to the length of the solar panel in meters. The third input field 308c may correspond to the number of solar panels. The fourth input field 308d may correspond to the material of the solar panels. The user 104 may input the set of solar panel parameters in the first through fourth input fields 308a-308d based on the interaction with the user interface 302 rendered on the computing device 102.

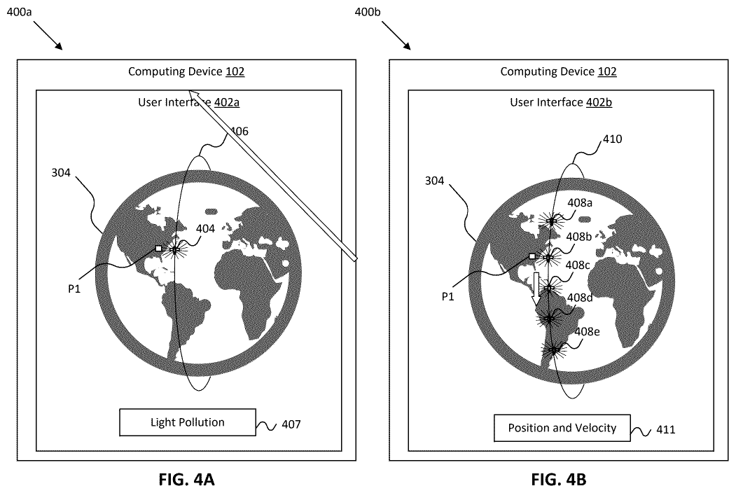

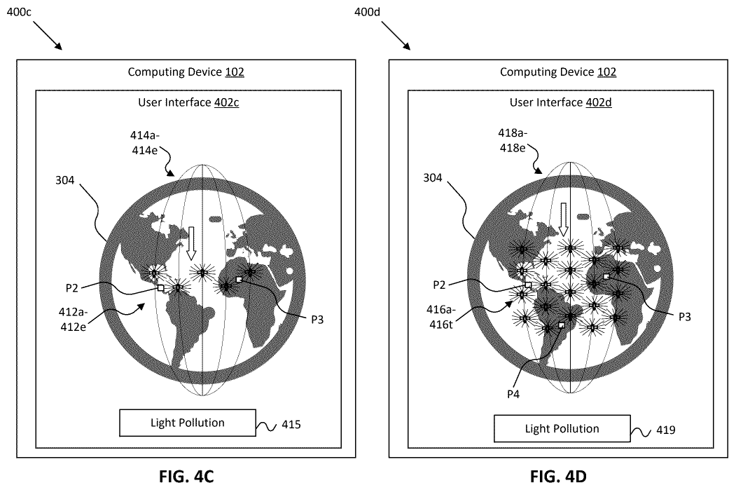

The interactive interface element 310 may correspond to a submit button that is selectable by the user 104 to trigger or initiate the simulation of the light pollution by the satellite system. When the user 104 selects the submit button, the computing device 102 may transmit the set of solar panel parameters to the application server 106 and the application server 106 may trigger the simulation of the light pollution and render one of the user interfaces (shown later in FIGS. 4A-4D).

FIG. 4A is a diagram 400a that represents an exemplary user interface 402a rendered on the computing device 102 in which aspects of the technology may be practiced. The user interface 402a presents the simulation of light pollution by a single satellite 404 of the satellite system 306 to iteratively determine light pollution at a plurality of point of interests by the single satellite 404 as the single satellite 404 traverses through an orbital plane 406 and the Earth 304. In at least some embodiments, the user interface 402a presents the simulation of light pollution by the single satellite 404 by way of scattering lines as shown in FIG. 4A to indicate scattering of light (light pollution) by the single satellite 404. The user interface 402a may further include an output field 407 that displays the light pollution by the single satellite 404 determined based on the simulation. In at least some embodiments, the output field 407 displays the light pollution by the single satellite 404 at a point of interest P1.

FIG. 4B is a diagram 400b that represents an exemplary user interface 402b rendered on the computing device 102 in which aspects of the technology may be practiced. The user interface 402b presents the simulation of light pollution by each of a plurality of satellites 408a-408e of the satellite system 306 in parallel to iteratively determine light pollution at the plurality of point of interests by each of the plurality of satellites 408a-408e as the plurality of satellites 408a-408e traverse through a single orbital plane 410 and the Earth 304. In at least some embodiments, the plurality of satellites 408a-408e may include five satellites that traverse through the single orbital plane 410. It may be understood by the person skilled in the art that the plurality of satellites 408a-408e may include any suitable number of satellites, without deviating from the scope of the present disclosure. In at least some embodiments, the user interface 402b presents the simulation of light pollution by the plurality of satellites 408a-408e by way of scattering lines as shown in FIG. 4B to indicate scattering of light (light pollution) by the plurality of satellites 408a-408e. The user interface 402b may further include an output field 411 that displays the light pollution at the plurality of point of interests by each of the plurality of satellites 408a-408e determined based on the simulation. In at least some embodiments, the output field 411 displays the cumulative light pollution by the plurality of satellites 408a-408e at the point of interest P1 while orbiting around the Earth 304.

FIG. 4C is a diagram 400c that represents an exemplary user interface 402c rendered on the computing device 102 in which aspects of the technology may be practiced. The user interface 402c presents the simulation of light pollution by each of a plurality of satellites 412a-412e of the satellite system 306 in parallel to iteratively determine light pollution at the plurality of point of interests by each of the plurality of satellites 412a-412e as the plurality of satellites 412a-412e traverse through a plurality of orbital planes 414a-414e and the Earth 304. In at least some embodiments, the plurality of satellites 412a-412e may include five satellites and the plurality of orbital planes 414a-414e may include five planes where there may be one satellite per orbital plane. It may be understood by the person skilled in the art that the plurality of satellites 412a-412e may include any suitable number of satellites and the plurality of orbital planes 414a-414e may include any suitable number of orbital planes, without deviating from the scope of the present disclosure. In at least some embodiments, the user interface 402c presents the simulation of light pollution by the plurality of satellites 412a-412e by way of scattering lines as shown in FIG. 4C to indicate scattering of light (light pollution) by the plurality of satellites 412a-412e. The user interface 402c may further include an output field 415 that displays the light pollution at the plurality of point of interests by each of the plurality of satellites 412a-412e determined based on the simulation. In at least some embodiments, the output field 415 displays the cumulative light pollution by the plurality of satellites 412a-412e at point of interests P2 and P3. FIG. 4D is a diagram 400d that represents an exemplary user interface 402d rendered on the computing device 102 in which aspects of the technology may be practiced. The user interface 402d presents the simulation of light pollution by each of a plurality of satellites 416a-416t of the satellite system 306 in parallel to iteratively determine light pollution at the plurality of point of interests by each of the plurality of satellites 416a-416t as the plurality of satellites 416a-416t traverse through a plurality of orbital planes 418a-418e and the Earth 304. In at least some embodiments, the plurality of satellites 416a-416t may include twenty satellites and the plurality of orbital planes 418a-418e may include five planes where there may be four satellites per orbital plane. It may be understood by the person skilled in the art that the plurality of satellites 416a-416t may include any suitable number of satellites, without deviating from the scope of the present disclosure. It may be understood by the person skilled in the art that the plurality of orbital planes 418a-418e may include any suitable number of orbital planes, without deviating from the scope of the present disclosure. In at least some embodiments, the user interface 402d presents the simulation of light pollution by the plurality of satellites 416a-416t by way of scattering lines as shown in FIG. 4D to indicate scattering of light (light pollution) by the plurality of satellites 416a-416t. The user interface 402d may further include an output field 419 that displays the light pollution at the plurality of point of interests by each of the plurality of satellites 416a-416t determined based on the simulation. In at least some embodiments, the output field 419 displays the cumulative light pollution by the plurality of satellites 416a-416t at point of interests P2, P3, and P4 while orbiting around the Earth 304.

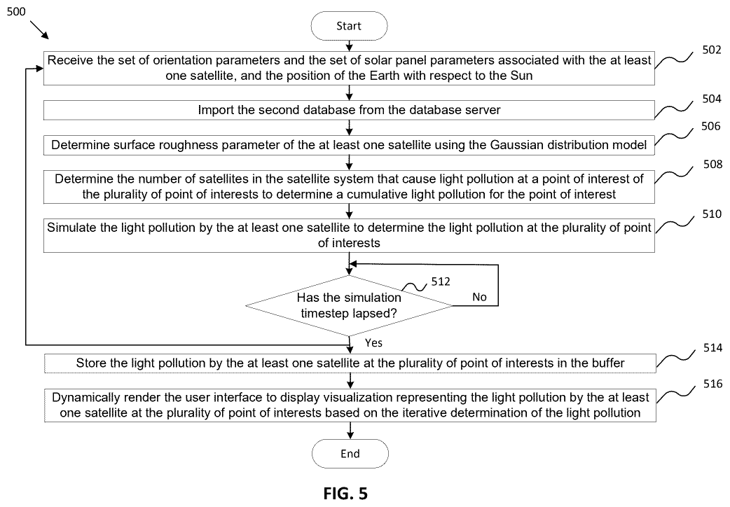

FIG. 5 illustrates a flow chart 500 of a method for simulating the light pollution by the at least one satellite according to aspects of the disclosed technology.

At 502, the parallel processor 202 may receive the set of orientation parameters and the set of solar panel parameters associated with the at least one satellite, and the position of the Earth with respect to the Sun. In at least some embodiments, the parallel processor 202 may receive the set of orientation parameters from the buffer 205. The set of orientation parameters may include the velocity, the position, and the orientation of the at least one satellite. The set of solar panel parameters may include at least one of the number of solar panels, the dimensions of the solar panels, the model of the solar panels, and the material of the solar panels. The material of the solar panels corresponds to one of the aluminum, the silver, and the titanium. The parallel processor 202 may receive the set of solar panel parameters from the computing device 102 based on the interaction by the user 104 with the user interface 302 rendered on the computing device 102.

At 504, the parallel processor 202 may import the second database from the database server 108. The second database includes the plurality of point of interests on the Earth. The plurality of point of interests on the Earth may correspond to the geographical locations of the observatory sites on the Earth.

At 506, the parallel processor 202 may determine the surface roughness parameter of the at least one satellite using the Gaussian distribution model. The Gaussian distribution model may include at least one of the probability model to determine the incoming energy from the Sun at the at least one satellite, the probability model to determine the surface roughness parameter of the at least one satellite, and the probability model to determine the outgoing energy by the surface of the at least one satellite.

At 508, the parallel processor 202 may determine the number of satellites in the satellite system that cause light pollution at a point of interest of the plurality of point of interests to determine a cumulative light pollution for the point of interest.

At 510, the parallel processor 202 simulate the light pollution by the at least one satellite to determine the light pollution at the plurality of point of interests based on at least one of the set of orientation parameters, the set of solar panel parameters, the position of the Earth with respect to the Sun, the surface roughness parameter, and the second database. The light pollution by the at least one satellite is iteratively determined as the at least one satellite traverses through the respective orbit of the at least one satellite.

In at least some embodiments, the light pollution by the at least one satellite may be iteratively determined based on the simulation timestep. In at least some embodiments, the light pollution by the at least one satellite may be iteratively determined when the user 104 modifies at least one of the set of orientation parameters and the set of solar panel parameters during the simulation of the light pollution. The user 104 may modify at least one of the set of orientation parameters and the set of solar panel parameters based on the interaction by the user 104 with the user interface 302 rendered on the computing device 102.

At 512, the parallel processor 202 may determine whether the simulation timestep has lapsed. If at 512, the parallel processor 202 determines that the simulation timestep has not lapsed, 512 is executed again. If at 512, the parallel processor 202 determines that the simulation timestep has lapsed, 514 and 502 are executed.

At 514, the parallel processor 202 may store the light pollution by the at least one satellite at the plurality of point of interests in the buffer 205 after the simulating the light pollution.

At 516, the parallel processor 202 may dynamically render the user interface to display the visualization representing the light pollution by the at least one satellite at the plurality of point of interests based on the iterative determination of the light pollution.

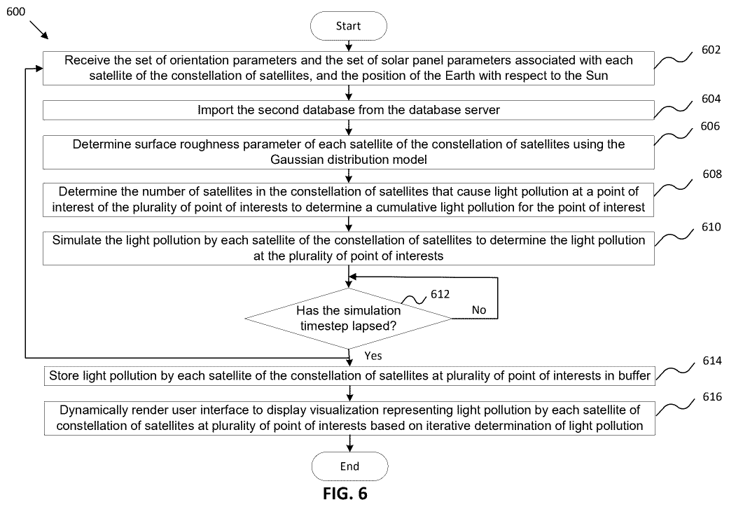

FIG. 6 illustrates a flow chart 600 of a method for simulating the light pollution by each satellite of the constellation of satellites according to aspects of the disclosed technology.

At 602, the parallel processor 202 may receive the set of orientation parameters and the set of solar panel parameters associated with each satellite of the constellation of satellites, and the position of the Earth with respect to the Sun. In at least some embodiments, the parallel processor 202 may receive the set of orientation parameters from the buffer 205. The set of orientation parameters may include the velocity, the position, and the orientation of each satellite of the constellation of satellites. The set of solar panel parameters may include at least one of the number of solar panels, the dimensions of the solar panels, the model of the solar panels, and the material of the solar panels. The material of the solar panels corresponds to one of the aluminum, the silver, and the titanium. The parallel processor 202 may receive the set of solar panel parameters from the computing device 102 based on the interaction by the user 104 with the user interface 302 rendered on the computing device 102.

At 604, the parallel processor 202 may import the second database from the database server 108. The second database includes the plurality of point of interests on the Earth. The plurality of point of interests on the Earth may correspond to the geographical locations of the observatory sites on the Earth.

At 606, the parallel processor 202 may determine the surface roughness parameter of each satellite of the constellation of satellites using the Gaussian distribution model. The Gaussian distribution model may include at least one of the probability model to determine the incoming energy from the Sun at each satellite of the constellation of satellites, the probability model to determine the surface roughness parameter of each satellite of the constellation of satellites, and the probability model to determine the outgoing energy by the surface of each satellite of the constellation of satellites.

At 608, the parallel processor 202 may determine the number of satellites in the constellation of satellites that cause light pollution at a point of interest of the plurality of point of interests to determine a cumulative light pollution for the point of interest.

At 610, the parallel processor 202 simulate the light pollution by each satellite of the constellation of satellites to determine the light pollution at the plurality of point of interests in parallel based on at least one of the set of orientation parameters, the set of solar panel parameters, the position of the Earth with respect to the Sun, the surface roughness parameter, and the second database. The light pollution by each satellite of the constellation of satellites is iteratively determined as each satellite of the constellation of satellites traverse through the respective orbit of each satellite of the constellation of satellites.

In at least some embodiments, the light pollution by each satellite of the constellation of satellites may be iteratively determined based on the simulation timestep. In at least some embodiments, the light pollution by each satellite of the constellation of satellites may be iteratively determined when the user 104 modifies at least one of the set of orientation parameters and the set of solar panel parameters during the simulation of the light pollution. The user 104 may modify at least one of the set of orientation parameters and the set of solar panel parameters based on the interaction by the user 104 with the user interface 302 rendered on the computing device 102.

At 612, the parallel processor 202 may determine whether the simulation timestep has lapsed. If at 612, the parallel processor 202 determines that the simulation timestep has not lapsed, 612 is executed again. If at 612, the parallel processor 202 determines that the simulation timestep has lapsed, 614 and 602 are executed.

At 614, the parallel processor 202 may store the light pollution by each satellite of the constellation of satellites at the plurality of point of interests in the buffer 205 after the simulating the light pollution.

At 616, the parallel processor 202 may dynamically render the user interface to display the visualization representing the light pollution by each satellite of the constellation of satellites at the plurality of point of interests based on the iterative determination of the light pollution.

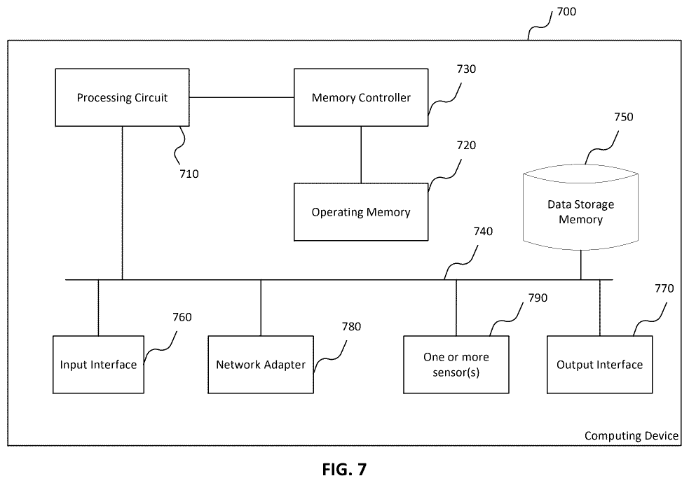

FIG. 7 is a diagram illustrating one example of computing device 700 in which aspects of the technology may be practiced. Computing device 700 may be virtually any type of general-purpose or specific-purpose computing device. For example, computing device 700 may be an example of the parallel processor 202, a computing system or device (e.g., computing device 102) associated with the satellite as described above with reference to FIGS. 1-6.

As illustrated in FIG. 7, computing device 700 includes processing circuit 710, operating memory 720, memory controller 730, data storage memory 750, input interface 760, output interface 770, and network adapter 780. Each of these afore-listed components of computing device 700 includes at least one hardware element.

Computing device 700 includes at least one processing circuit 710 configured to execute instructions, such as instructions for implementing the herein-described workloads, processes, or technology. Processing circuit 710 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 720 during run-time of computing device 700. Operating memory 720 may also include any of a variety of data storage devices/components, such as volatile memories, semi-volatile memories, random access memories, static memories, caches, buffers, or other media used to store run-time information. In one example, operating memory 720 does not retain information when computing device 700 is powered off. Rather, computing device 700 may be configured to transfer instructions from a non-volatile data storage component (e.g., data storage memory 750) to operating memory 720 as part of a booting or other loading process. In some examples, other forms of execution may be employed, such as execution directly from data storage memory 750.

Operating memory 720 may include 4th generation double data rate (DDR4) memory, 3rd generation double data rate (DDR3) memory, other dynamic random access memory (DRAM), High Bandwidth Memory (HBM), Hybrid Memory Cube memory, 3D-staked memory, static random access memory (SRAM), magneto resistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 710 via memory controller 730 in channels. One example of computing device 700 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 720 specifically does not include or encompass communications media, any communications medium, or any signals per se.

Memory controller 730 is configured to interface processing circuit 710 to operating memory 720. For example, memory controller 730 may be configured to interface commands, addresses, and data between operating memory 720 and processing circuit 710. Memory controller 730 may also be configured to abstract or otherwise manage certain aspects of memory management from or for processing circuit 710. Although memory controller 730 is illustrated as single memory controller separate from processing circuit 710, in other examples, multiple memory controllers may be employed, memory controller(s) may be integrated with operating memory 720, or the like. Further, memory controller(s) may be integrated into processing circuit 710. These and other variations are possible.

In computing device 700, data storage memory 750, input interface 760, output interface 770, and network adapter 780 are interfaced to processing circuit 710 by bus 740. Although, FIG. 7 illustrates bus 740 as a single passive bus, other configurations, such as a collection of buses, a collection of point-to-point links, an input/output controller, a bridge, other interface circuitry, or any collection thereof may also be suitably employed for interfacing data storage memory 750, input interface 760, output interface 770, or network adapter 780 to processing circuit 710.

In computing device 700, data storage memory 750 is employed for long-term non-volatile data storage. Data storage memory 750 may include any of a variety of non-volatile data storage devices/components, such as non-volatile memories, disks, disk drives, hard drives, solid-state drives, or any other media that can be used for the non-volatile storage of information. However, data storage memory 750 specifically does not include or encompass communications media, any communications medium, or any signals per se. In contrast to operating memory 720, data storage memory 750 is employed by computing device 700 for non-volatile long-term data storage, instead of for run-time data storage.

Also, computing device 700 may include or be coupled to any type of processor-readable media such as processor-readable storage media (e.g., operating memory 720 and data storage memory 750) and communication media (e.g., communication signals and radio waves). While the term processor-readable storage media includes operating memory 720 and data storage memory 750, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 700 also includes input interface 760, which may be configured to enable computing device 700 to receive input from users or from other devices. In addition, computing device 700 includes output interface 770, which may be configured to provide output from computing device 700.

In the illustrated example, computing device 700 is configured to communicate with other computing devices or entities via network adapter 780. Network adapter 780 may include a wired network adapter, e.g., an Ethernet adapter, a Token Ring adapter, or a Digital Subscriber Line (DSL) adapter. Network adapter 780 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 700 is illustrated with certain components configured in a particular arrangement, these components and arrangement are merely one example of a computing device in which the technology may be employed. In other examples, data storage memory 750, input interface 760, output interface 770, or network adapter 780 may be directly coupled to processing circuit 710, or be coupled to processing circuit 710 via an input/output controller, a bridge, or other interface circuitry. Other variations of the technology are possible.

Some examples of computing device 700 include at least one memory (e.g., operating memory 720) adapted to store run-time data and at least one processor (e.g., processing circuit 710) that is adapted to execute processor-executable code that, in response to execution, enables computing device 700 to perform actions, where the actions may include, in some examples, actions for one or more methodologies or processes described herein, such as, methods of FIG. 5 and FIG. 6, as described above.

The device or system of the present disclosure may additionally include one or more sensors 790 to sense or gather data pertaining to the surrounding environment or operation of the device or system. Some exemplary sensors capable of being electronically coupled with the device or system of the present disclosure (either directly connected to the device or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; magnetometers measuring the magnetic field experienced or observed by the satellite; star trackers capturing images of stars and comparing them to known star charts to precisely determine the satellite's orientation; sun sensor detecting and measuring the direction of the Sun; Earth sensor measuring the satellite's orientation and determines its attitude or position with respect to the Earth's surface; altimeters sensing barometric pressure, altitude change, terrain climbed, local pressure changes, submersion in liquid; impellers measuring the amount of fluid passing thereby; Global Positioning and GNSS sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

The device or system of the present disclosure may include wireless communication logic coupled to sensors on the device or system. The sensors gather data and provide the data to the wireless communication logic. Then, the wireless communication logic may transmit the data gathered from the sensors to a remote device. Thus, the wireless communication logic may be part of a broader communication system, in which one or several devices or systems of the present disclosure may be networked together to report alerts and, more generally, to be accessed and controlled remotely. Depending on the types of transceivers installed in the device or system of the present disclosure, the system may use a variety of protocols (e.g., Wifi, ZigBee, MiWi, Bluetooth) for communication. In one example, each of the devices or systems of the present disclosure may have its own IP address and may communicate directly with a router or gateway. This would typically be the case if the communication protocol is WiFi.

In another example, a point-to-point communication protocol like MiWi or ZigBee is used. One or more of the device or system of the present disclosure may serve as a repeater, or the devices or systems of the present disclosure may be connected together in a mesh network to relay signals from one device or system to the next. However, the individual device or system in this scheme typically would not have IP addresses of their own. Instead, one or more of the devices or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system also allows individuals to access the device or system of the present disclosure for configuration and diagnostic purposes. In that case, the individual processors or microcontrollers of the device or system of the present disclosure may be configured to act as Web servers that use a protocol like hypertext transfer protocol (HTTP) to provide an online interface that can be used to configure the device or system. In some embodiments, the systems may be used to configure several devices or systems of the present disclosure at once. For example, if several devices or systems are of the same model and are in similar locations in the same location, it may not be necessary to configure the devices or systems individually. Instead, an individual may provide configuration information, including baseline operational parameters, for several devices or systems at once.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic,” as used herein, includes but is not limited to hardware, firmware, software, and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, In at least some embodiments, to A only (optionally including elements other than B); In at least some embodiments, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, In at least some embodiments, to at least one, optionally including more than one, A, with no B present (and optionally including elements other than B); In at least some embodiments, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected,” “attached” or “coupled” to another feature or element, it can be directly connected, attached, or coupled to the other feature or element or intervening features or elements may be present. In contrast, when a feature or element is referred to as being “directly connected,” “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly,” “downwardly,” “vertical,” “horizontal,” “lateral,” “transverse,” “longitudinal,” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

If this specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed:

1. A method for simulating light pollution by a satellite system comprising at least one satellite, the method comprising:
receiving a set of orientation parameters and a set of solar panel parameters associated with the at least one satellite, and a position of the Earth with respect to the Sun;
importing a database comprising a plurality of point of interests on the Earth;
determining a surface roughness parameter of the at least one satellite using a Gaussian distribution model;
based on at least one of the set of orientation parameters, the set of solar panel parameters, the position of the Earth with respect to the Sun, the surface roughness parameter, and the database: simulating the light pollution by the at least one satellite to determine the light pollution at the plurality of point of interests, wherein the light pollution by the at least one satellite is iteratively determined as the at least one satellite traverses through a respective orbit of the at least one satellite;
storing the light pollution determined at the plurality of point of interests in a buffer after simulation; and
dynamically rendering a user interface to display a visualization representing the light pollution by the at least one satellite at the plurality of point of interests based on the iterative determination of the light pollution.

2. The method of claim 1, wherein the plurality of point of interests on the Earth corresponds to geographical locations of a plurality of observatory sites on the Earth.

3. The method of claim 1, wherein the set of orientation parameters comprises at least one of:
a position and an orientation of the at least one satellite.

4. The method of claim 1, wherein the set of solar panel parameters comprises at least one of:
a number of solar panels, dimensions of the solar panels, a model of the solar panels, and a material of the solar panels.

5. The method of claim 4, wherein the material of the solar panels corresponds to one of aluminum, silver, and titanium.

6. The method of claim 1, wherein the Gaussian distribution model comprises at least one of:
a probability model to determine an incoming energy from the Sun at the at least one satellite,
a probability model to determine the surface roughness parameter of the at least one satellite, and
a probability model to determine an outgoing energy by a surface of the at least one satellite.

7. The method of claim 1, further comprising:
determining a number of satellites in the satellite system that cause light pollution at a point of interest of the plurality of point of interests to determine a cumulative light pollution for the point of interest.

8. The method of claim 1, wherein the set of orientation parameters and the set of solar panel parameters are input based on an interaction with the user interface rendered on a computing device.

9. The method of claim 8, wherein the light pollution by the at least one satellite is iteratively determined when at least one of the set of orientation parameters and the set of solar panel parameters are modified.

10. A method for simulating light pollution by a satellite system comprising a constellation of satellites, the method comprising:
receiving a set of orientation parameters and a set of solar panel parameters associated with each satellite of the constellation of satellites, and a position of the Earth with respect to the Sun;
importing a database comprising a plurality of point of interests on the Earth;
determining a surface roughness parameter of each satellite of the constellation of satellites using a Gaussian distribution model;
based on at least one of the set of orientation parameters, the set of solar panel parameters, the position of the Earth with respect to the Sun, the surface roughness parameter, and the database: simulating, via a parallel processor, the light pollution by each satellite of the constellation of satellites to determine the light pollution at the plurality of point of interests, wherein the light pollution by each satellite of the constellation of satellites are iteratively determined as each satellite of the constellation of satellites traverse through a respective orbit of each satellite of the constellation of satellites;
storing the light pollution determined at the plurality of point of interests in a buffer after simulation; and
dynamically rendering a user interface to display a visualization representing the light pollution by each satellite of the constellation of satellites at the plurality of point of interests based on the iterative determination of the light pollution.

11. The method of claim 10, wherein the plurality of point of interests on the Earth corresponds to geographical locations of a plurality of observatory sites on the Earth.

12. The method of claim 10, wherein the set of orientation parameters comprises at least one of:
a position and an orientation of each satellite of the constellation of satellites.

13. The method of claim 10, wherein the set of solar panel parameters comprises at least one of:
a number of solar panels, dimensions of the solar panels, a model of the solar panels, and a material of the solar panels.

14. The method of claim 13, wherein the material of the solar panels corresponds to one of aluminum, silver, and titanium.

15. The method of claim 10, wherein the Gaussian distribution model comprises at least one of:
a probability model to determine an incoming energy from the Sun at each satellite of the constellation of satellites,
a probability model to determine the surface roughness parameter of each satellite of the constellation of satellites, and
a probability model to determine an outgoing energy by a surface of each satellite of the constellation of satellites.

16. The method of claim 10, further comprising:
determining a number of satellites in the constellation of satellites that cause light pollution at a point of interest of the plurality of point of interests to determine a cumulative light pollution for the point of interest.

17. The method of claim 10, wherein the set of orientation parameters and the set of solar panel parameters are input based on an interaction with the user interface rendered on a computing device.

18. The method of claim 17, wherein the light pollution by each satellite of the constellation of satellites are iteratively determined when at least one of the set of orientation parameters and the set of solar panel parameters are modified.

19. A system for simulating light pollution by a satellite system comprising at least one satellite, the system comprising:
at least one hardware-based processor and memory, wherein the memory comprises processor-executable instructions encoded on a non-transient processor-readable media, wherein the processor-executable instructions, when executed by the at least one hardware-based processor, configure the system to:
receive a set of orientation parameters and a set of solar panel parameters associated with the at least one satellite, and a position of the Earth with respect to the Sun;
import a database comprising a plurality of point of interests on the Earth;
determine a surface roughness parameter of the at least one satellite using a Gaussian distribution model;
based on at least one of the set of orientation parameters, the set of solar panel parameters, the position of the Earth with respect to the Sun, the surface roughness parameter, and the database: simulating the light pollution by the at least one satellite to determine the light pollution at the plurality of point of interests, wherein the light pollution by the at least one satellite is iteratively determined as the at least one satellite traverses through a respective orbit of the at least one satellite;
store the light pollution determined at the plurality of point of interests in a buffer after simulation; and
dynamically rendering a user interface to display a visualization representing the light pollution by the at least one satellite at the plurality of point of interests based on the iterative determination of the light pollution.

20. A non-transitory computer-readable medium storing a set of instructions for simulating light pollution by a satellite system comprising at least one satellite, the set of instructions comprising:
one or more instructions that, when executed by one or more processors of a device, cause the device to:
receive a set of orientation parameters and a set of solar panel parameters associated with the at least one satellite, and a position of the Earth with respect to the Sun;
import a database comprising a plurality of point of interests on the Earth;
determine a surface roughness parameter of the at least one satellite using a Gaussian distribution model;
based on at least one of the set of orientation parameters, the set of solar panel parameters, the position of the Earth with respect to the Sun, the surface roughness parameter, and the database: simulating the light pollution by the at least one satellite to determine the light pollution at the plurality of point of interests, wherein the light pollution by the at least one satellite is iteratively determined as the at least one satellite traverses through a respective orbit of the at least one satellite;
store the light pollution determined at the plurality of point of interests in a buffer after simulation; and
dynamically rendering a user interface to display a visualization representing the light pollution by the at least one satellite at the plurality of point of interests based on the iterative determination of the light pollution.
